(19) United States
(12) Patent Application Publication
(10) Pub. No.: US 2026/0079713 A1
(43) Pub. Date: Mar. 19, 2026

(54) PARALLEL PROCESSING MEMORY TRAFFIC AGGREGATION

(71) Applicants: ADVANCED MICRO DEVICES, INC., Santa Clara, CA (US); ATI TECHNOLOGIES ULC, Markham (CA)

(72) Inventors: Ahmed Mohammed EIShafiey Mohammed EITantawy, Woodbridge (CA); Subramaniam Maiyuran, Folson, CA (US); Trinayan Baruah, San Diego, CA (US); Ramkumar Jayaseelan, Austin, TX (US)

(21) Appl. No.: 18/887,927

(22) Filed: Sep. 17, 2024

(51) Int. Cl. G06F 9/38; G06F 9/30

(52) U.S. Cl. CPC G06F 9/3885; G06F 9/3004

(57) ABSTRACT

A processor includes a plurality of execution units that perform respective portions of a parallel execution. As part of the parallel execution, each execution unit requests respective execution data via a respective memory request. A request aggregation circuit combines received memory requests from the execution units. Combining the requests includes identifying the memory requests as corresponding to the same execution data, sending a single representative memory request for the execution data, receiving a single instance of the execution data, and providing the respective execution data to each requesting execution unit.

### BACKGROUND

Some parallel processing units include multiple compute units that concurrently perform operations for instructions received by the parallel processing unit. In some cases, the compute units each include one or more single-instruction, multiple data (SIMD) units that are programmed to perform the same operation on different data sets to produce one or more results. In some cases, the parallel processor also includes a command processor that dispatches instructions for execution by the compute units, (e.g., by providing data indicating one or more operations, operands, instructions, variables, register files, or any combination thereof to the compute units). Because, in some cases, each compute unit operates separately, parallel processors are often used for computations that can be broken down into multiple threads that are dispatched to different compute units. For example, in a graphics pipeline on a graphics processing unit (GPU), each of the compute units is programmed to implement a vertex shader so that the graphics pipeline can concurrently process multiple vertices of a polygon mesh model of a scene. In some cases, the compute units are implemented in multiple (e.g., two) shader engines, and the command processor supports multiple (e.g., four) pipelines that process instructions received from associated queues. For example, the command processor dispatches instructions from the currently active queue for each pipeline to be executed by a subset of the compute units in the shader engines.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing system that aggregates parallel processing memory traffic in accordance with some implementations.

FIG. 2 is a block diagram of a processing system that includes request aggregation circuits that combine received memory requests from execution units in accordance with some implementations.

FIG. 3 is a flow diagram of an example memory request and memory response performed by a processing system that aggregates parallel processing memory traffic in accordance with some implementations.

FIG. 4 is a block diagram of an example execution of portions of a parallel execution using a processing system that aggregates parallel processing memory traffic in accordance with some implementations.

FIG. 5 is a flow diagram of a method of combining received memory requests and providing received data in accordance with some implementations.

### DETAILED DESCRIPTION

Parallel processing frequently involves performing similar operations on the same execution data or similarly located execution data (e.g., adjacent, sharing a same memory page, or sharing a same group of memory pages). In some cases, as part of a parallel execution, execution units (e.g., shader engines, compute units, single instruction multiple data (SIMD) units, a combination thereof, etc.) each request the same execution data or similarly located execution data located within a memory external to the execution units (e.g., a level 1 (L1) cache or a level 2 (L2) cache). In some implementations, a request aggregation circuit receives memory requests, combines the received requests into a single representative memory request that is sent to the memory. Subsequently, after the execution data is received from the memory, the request aggregation circuit provides received execution data to the execution units (e.g., by multicasting the received data or by sending the received data to each execution unit individually).

In some systems, the execution units each request the data from the memory, causing the system to create a memory request for each execution unit and a memory response for each execution unit. These requests consume an undesirable amount of bandwidth. Further, in some cases, additional mechanisms (e.g., barrier instructions or synchronization controllers) are put in place to ensure that the programs or threads executed by execution units remain synchronized. In some cases, these mechanisms have negative effects on the system as a whole, such as negatively impacting the timing of the system or consuming an undesirable amount of power, area, or both.

Because the request aggregation circuit combines received memory requests, the memory requests collectively consume bandwidth corresponding to a single memory request between the request aggregation circuit and the memory. Further, in some implementations, as part of providing the execution data to the execution units, the request aggregation circuit waits until memory requests have been received from each execution unit or until a timeout duration expires. When all memory requests have been received or the timeout duration expires, the request aggregation circuit multicasts the execution data to the execution units. As a result, the execution data is provided to each requesting execution unit without sending individual memory responses. In some implementations, execution is naturally synchronized without an explicit synchronization mechanism and without slowing execution of a slowest execution unit, which, in some cases, represents a critical path in the parallel execution. In implementations where the timeout duration is used, the timeout duration bounds overall system latency, and, as further discussed below, in some cases is used to better synchronize execution units that are falling behind. Further, in some implementations, the request aggregation circuit enables hardware to know where to return data physically and also enables the system to change allocation of portions of the parallel execution to different execution units.

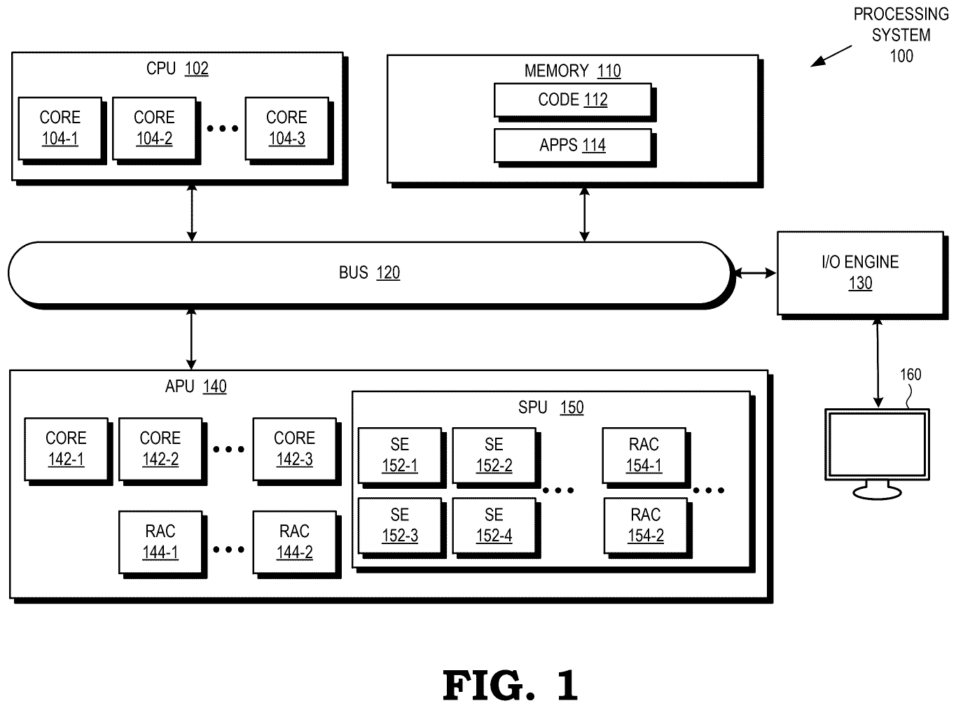

For purposes of description, FIGS. 1-5 are described with respect to examples where request aggregation circuits that combine received memory requests from execution units within an accelerated processing unit (APU) that is performing a parallel execution. However, it will be appreciated that, in other implementations, the techniques described herein are implemented at different types of processing circuits, are implemented to traverse a different type of acceleration structure, or any combination thereof. For example, in various implementations, the techniques described herein are implemented at one or more central processing units (CPUs), vector processors, coprocessors, GPUs, general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), application specific integrated circuits, or any combination thereof.

FIG. 1 illustrates an example of a processing system 100 that aggregates parallel processing memory traffic in accordance with some implementations. Processing system 100 includes or has access to a memory 110 or other storage component implemented using a non-transitory computer-readable medium, for example, a dynamic random-access memory (DRAM). However, in some implementations, memory 110 is implemented using other types of memory including, for example, static random-access memory (SRAM), nonvolatile RAM, and the like. According to some implementations, memory 110 includes an external memory implemented external to the processing units implemented in processing system 100. Processing system 100 also includes a bus 120 to support communication between entities in processing system 100, such as memory 110. Some implementations of processing system 100 include other buses, bridges, switches, routers, and the like, which are not shown in FIG. 1 in the interest of clarity.

The techniques described herein are, in various implementations, employed at least in part at accelerated processing unit (APU) 140, also referred to as an accelerated processor. APU 140 includes, for example, any of a variety of central processing units (CPUs), parallel processors, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. In some implementations, APU 140 renders images according to one or more applications 114 (e.g., shader programs) for presentation on a display 160. For example, APU 140 renders objects (e.g., groups of primitives) according to one or more shader programs to produce values of pixels that are provided to display 160, which uses the pixel values to display an image that represents the rendered objects.

To render the objects, the APU 140 includes a plurality of cores 142 that execute instructions concurrently or in parallel from, for example, one or more applications 114. For example, the APU 140 executes instructions from a shader program, raytracing program, graphics pipeline, or both using a plurality of cores 142 to render one or more objects. Though in the example implementation illustrated in FIG. 1, three processor cores (142-1 to 142-3) are presented, the number of cores 142 in APU 140 is a matter of design choice. As such, in other implementations, the APU 140 can include any number of cores 142. Some implementations of the APU 140 are used for general-purpose computing. APU 140 executes instructions such as program code 112 (e.g., shader code, raytracing code) for one or more applications 114 (e.g., shader programs, raytracing programs) stored in memory 110, and APU 140 stores information in memory 110 such as the results of the executed instruction.

The APU 140 further includes a shader processing unit (SPU) 150, which in the depicted implementation, includes a plurality of shader engines 152. Though in the example implementation illustrated in FIG. 1, four shader engines (152-1 to 152-4) are presented, the number of shader engines 152 in APU 140 is a matter of design choice. Each of the shader engines 152 includes one or more workgroup processors (WGPs), omitted here for clarity.

In the depicted implementation, APU 140 includes a plurality of request aggregation circuits 144. Request aggregation circuits 144 combine memory requests between respective sets of cores 142 and a memory such as memory 110 when the respective cores 142 are performing a parallel execution. Similarly, SPU 150 includes a plurality of request aggregation circuits 154 that combine memory requests between respective sets of shader engines 152 when the respective shader engines 152 are performing a parallel execution. Though in the example implementation illustrated in FIG. 1, four request aggregation circuits (144-1 to 144-2 and 154-1 to 154-2) are presented, the number of request aggregation circuits is a matter of design choice. Further, in some implementations, processing system 100 includes request aggregation circuits that combine memory requests between other execution units (e.g., between APU 140 and CPU 102 or between two WGPs of shader engine 152-3). Additionally, in the illustrated implementation, processing system 100 includes request aggregation circuits that separately combine requests between different groups of execution units (e.g., between cores 142 and separately between shader engines 152). However, in other implementations, processing system 100 only includes a single request aggregation circuit or only includes request aggregation circuits that combine requests between a single group of execution units (e.g., between cores 142). Further, although request aggregation circuits 144 are depicted as being part of APU 140, in other implementations, request aggregation circuits 144 are located elsewhere between the corresponding execution units and the corresponding memory (e.g., between cores 142 and memory 110), such as outside APU 140. Similarly, in other implementations, request aggregation circuits 154 are located elsewhere between the corresponding execution units and the corresponding memory (e.g., between shader engines 152 and a memory), such as outside SPU 150.

Processing system 100 also includes a central processing unit (CPU) 102 that communicates with APU 140 and memory 110 via the bus 120. CPU 102 includes a plurality of cores 104 that execute instructions concurrently or in parallel. In some implementations, one or more of the cores 104 each operate as one or more compute units (e.g., Single Instruction Multiple Data or SIMD units) that perform the same operation on different data sets. Though in the example implementation illustrated in FIG. 1, three processor cores (104-1 to 104-3) are presented, the number of cores 104 is a matter of design choice. As such, in other implementations, CPU 102 can include any number of cores 104. In some implementations, the CPU 102 and the APU 140 have an equal number of processor cores, while in other implementations, the CPU 102 and the APU 140 have a different number of processor cores. The cores 104 execute instructions such as program code 112 stored in memory 110 and CPU 102 stores information in memory 110 such as the results of the executed instructions. CPU 102 is also able to initiate graphics processing by issuing draw calls to the APU 140. In some implementations, CPU 102 includes multiple processor cores that execute instructions concurrently or in parallel.

An input/output (I/O) engine 130 includes hardware and software to handle input or output operations associated with display 160, as well as other elements of processing system 100 such as keyboards, mice, printers, external disks, and the like. I/O engine 130 is coupled to bus 120 so that I/O engine 130 communicates with memory 110, APU 140, CPU 102, or any combination thereof.

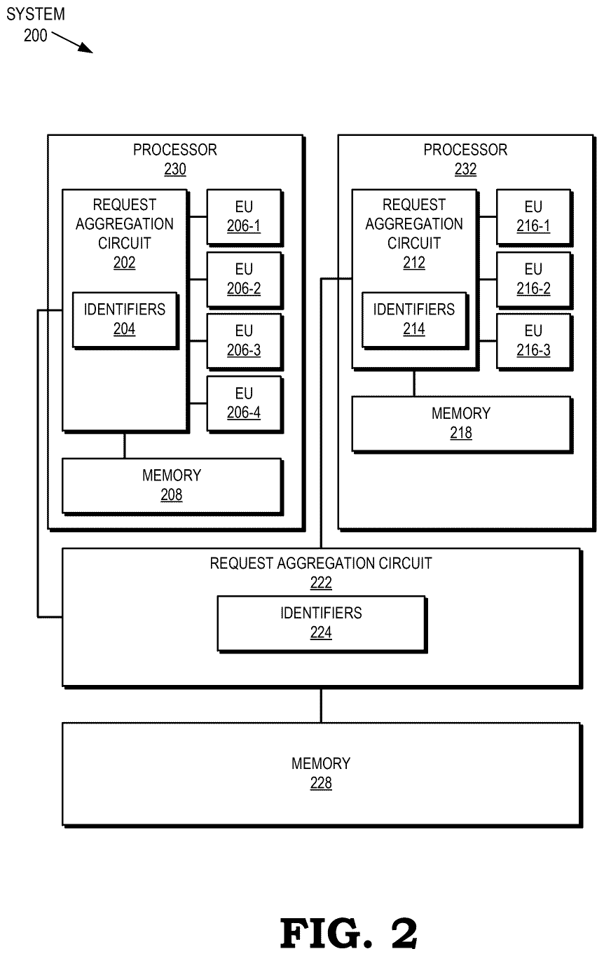

Referring now to FIG. 2, a processing system 200 that includes request aggregation circuits that combine received memory requests from execution units is shown, in accordance with some implementations. Processing system 200 includes processors 230 and 232, request aggregation circuit 222, and memory 228. Processor 230 includes request aggregation circuit 202, a plurality of execution units 206, and memory 208. Request aggregation circuit 202 is configured to store a plurality of identifiers 204. Processor 232 includes request aggregation circuit 212, a plurality of execution units 216, and memory 218. Request aggregation circuit 212 is configured to store a plurality of identifiers 214. Request aggregation circuit 222 is configured to store a plurality of identifiers 224. In some implementations, some or all of processing system 200 corresponds to portions of processing system 100. For example, in some implementations, processor 230 corresponds to APU 140, execution units 206 correspond to cores 142, processor 232 corresponds to CPU 102, and execution units 216 correspond to cores 104. Although FIG. 2 illustrates processors 230 and 232, in some implementations, request aggregation circuits 202 and 212 are part of a single processor. For example, in some implementations, both processor 230 and processor 232 correspond to SPU 150, execution units 206 correspond to a portion of shader engines 152, and execution units 216 correspond to another portion of shader engines 152. Further, in some implementations, one or both of request aggregation circuits 202 and 212 are located outside of processors 230 and 232. In the illustrated implementation, for clarity, memories 208 and 218 are L1 caches and memory 228 is an L2 cache. However, in other implementations, memories 208, 218, and 228 are other memory devices.

In the illustrated implementation, some or all of execution units 206 perform respective portions of a parallel execution. Request aggregation circuit 202 receives (e.g., by being addressed directly or by intercepting) memory requests from execution units 206 that address memory 208, memory 228, or both. In response to receiving a memory request (e.g., from execution unit 206-2), request aggregation circuit 202 identifies (e.g., based on an identifier in the memory request, an identifier stored at identifiers 204, or both) that the request is part of a parallel execution. Request aggregation circuit 202 sends a single representative memory request for the execution data on behalf of one or more of execution units 206. In some cases, the representative memory request additionally indicates execution data not requested by the memory request received from the execution unit (e.g., because the representative memory request additionally asks for data having a fixed relationship to the execution data of the memory request, such as data preceding or following the execution data of the memory request). As a result, in some cases, fewer memory requests are sent along communication circuitry between request aggregation circuit 202 and the addressed memory, as compared to a system where memory requests are sent directly between the execution units and the addressed memory. Further, if a memory request from execution 206-4 is received that is part of the parallel execution, in some cases, the execution data has already been requested.

In response to receiving the execution data, request aggregation circuit 202 provides the execution data to each requesting execution unit (e.g., execution units 206-2 and 206-4). In some implementations, the execution data is provided to each requesting execution unit via a separate communication. In some implementations, when the requested execution data is the same, request aggregation circuit 202 provides the execution data by multicasting it to execution units 206, reducing an amount of data sent along communication circuitry between request aggregation circuit 202 and execution units 206 as compared to a system where memory requests are sent directly between the execution units and the addressed memory. In some implementations, request aggregation circuit 202 waits until all members of a parallel execution group of execution units have requested the execution data or until a timeout duration expires before providing the execution data to the requesting execution units. As a result, in some cases, request aggregation circuit 202 avoids sending the execution data multiple times because more execution units are waiting for the execution data. However, because the execution is a parallel execution, in some cases, delaying execution by execution units (e.g., execution unit 206-2) that request the execution data early as compared to other execution units does not increase a computation time of the parallel execution.

In some implementations, memory requests for the execution data are considered received from all members of the group if the only outstanding memory requests are from execution units which have previously failed to request previous execution data prior to expiration of the timeout duration. In other words, if the only outstanding requests are from execution units which have previously timed out, request aggregation circuit 202 refrains from waiting a remainder of the timeout duration. As a result, if execution at an execution unit fails, the remainder of the parallel execution continues to progress. In some implementations, memory requests for the execution data are considered received from all members of the group if the requesting execution unit previously failed to request previous execution data prior to expiration of a previous timeout duration (e.g., a duration having the same length as the timeout duration but for the previous execution data). As a result, if an execution unit falls behind, the execution unit does not wait for other execution units, potentially allowing the behind execution unit to catch up to the other execution units.

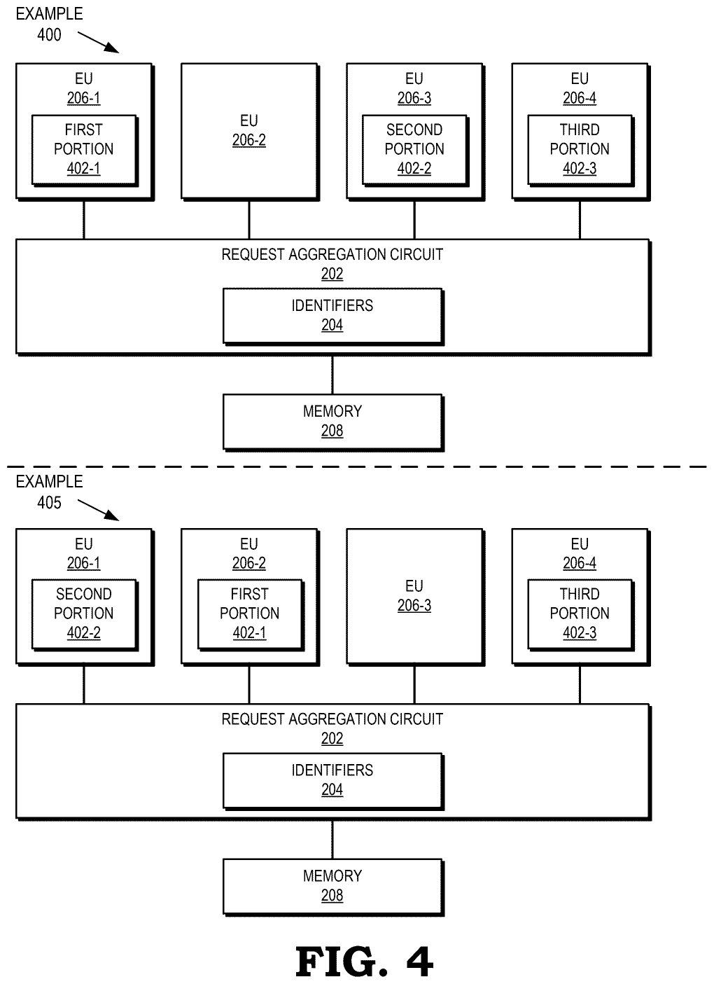

As discussed above, an identifier in the memory request, an identifier stored at identifiers 204, or both, is used to determine that a request is part of a parallel execution. In some implementations, at least one memory request is a load multicast instruction that indicates that the load will be performed in parallel by a group of execution units 206 and further indicates the group. In some implementations, memory requests include a parallel execution group identifier. If a received parallel execution group identifier is not found in identifiers 204, a new parallel execution group is added to identifiers, including the execution unit that sent the parallel execution group identifier. As additional memory requests are received that include the parallel execution group identifier, corresponding execution units are added to the parallel execution group. In some implementations, the indication of the group is received separately. In some implementations, when a memory request is received, request aggregation circuit 202 compares an execution identifier (e.g., a logical identifier of a corresponding portion of the parallel execution as further discussed below with reference to FIG. 4 or a device identifier) to groups of identifiers stored at identifiers 204 to match the memory request to a corresponding group of memory requests. In other implementations, the memory request indicates a corresponding group of memory requests (e.g., via a group identifier).

In the illustrated implementation, processor 232 and request aggregation circuit 212 combine received memory requests from execution units 216 in a manner similar to processor 230 and request aggregation circuit 202, as described above.

Request aggregation circuit 222 and identifiers 224 illustrate the hierarchical nature of some implementations. More specifically, in various implementations, request aggregation circuit 222 combines memory requests from one or more request aggregation circuits, one or more execution units, or both. For example, in some implementations, based on identifiers 224, request aggregation circuit 222 combines a memory request from request aggregation circuit 202 to memory 228 with a memory request from request aggregation circuit 212 to memory 228. Accordingly, in some cases, request aggregation circuit 202 combines memory requests from a plurality of execution units (e.g., execution units 206-1 and 206-3), request aggregation circuit 212 combines memory requests from a different plurality of execution units (e.g., execution units 216-1 and 216-2), and request aggregation circuit 222 combines the memory requests from request aggregation circuits 202 and 212.

As another example, in some implementations, based on identifiers 224, request aggregation circuit 222 combines a memory request from execution unit 206-3 to memory 228 with a memory request from execution unit 216-2 to memory 228. As yet another example, in some implementations, based on identifiers 224, request aggregation circuit 222 combines a memory request from execution unit 206-4 with a memory request from request aggregation circuit 212.

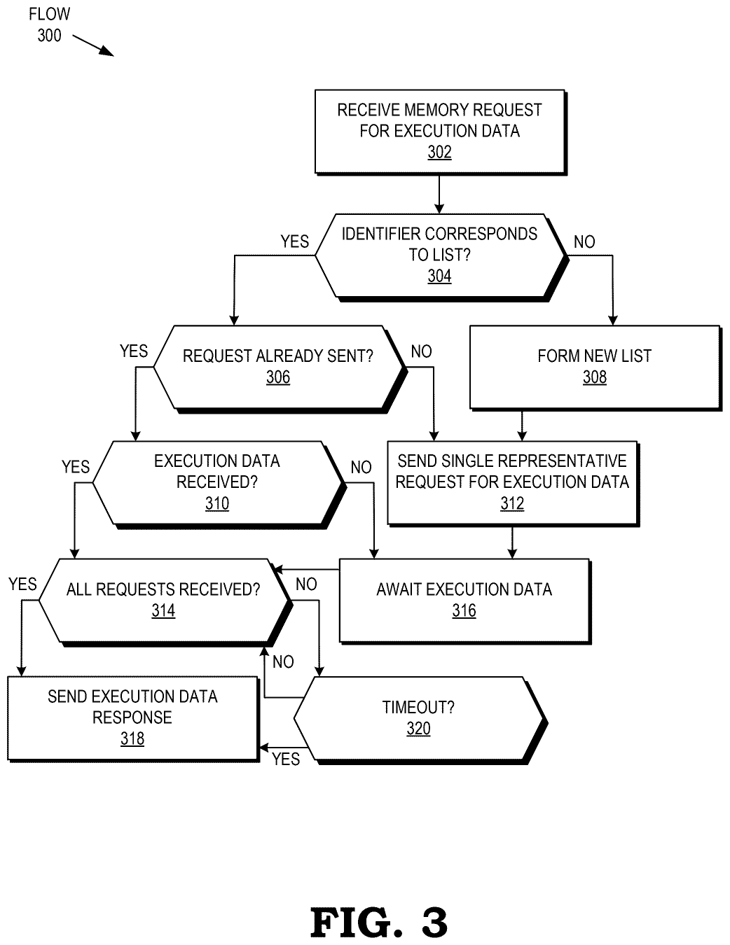

FIG. 3 is a flow diagram illustrating a flow 300 of an example memory request and memory response performed by a processing system that aggregates parallel processing memory traffic in accordance with some implementations. In some implementations, various portions are not performed or are performed differently than as depicted. For example, in some implementations, block 320 is not performed and the flow waits at block 314 until all requests are received. As a second example, in some implementations, all requests are treated as being received if the only remaining execution units or request aggregation circuits that have not yet requested the execution data previously failed to request previous execution data prior to expiration of a previous timeout duration. As a third example, in some implementations, all requests are treated as being received if a requesting execution unit or request aggregation circuit previously failed to request previous execution data prior to expiration of a previous timeout duration. In some implementations, flow 300 is initiated by one or more processors in response to one or more instructions stored by a computer readable storage medium.

At block 302, a request aggregation circuit receives a memory request for execution data. For example, request aggregation circuit 222 of FIG. 2 receives a memory request for execution data stored at memory 228 from execution unit 206-2 or from request aggregation circuit 202. At block 304, the request aggregation circuit determines whether an identifier corresponding to the memory request corresponds to a list. For example, request aggregation circuit 222 determines whether a logical identifier sent with the memory request corresponds to an entry of identifiers 224.

If the identifier corresponding to the memory request does not correspond to the list, at block 308, a new list is formed including the identifier. For example, in response to receiving a load multicast instruction that indicates a plurality of identifiers corresponding to respective portions of a parallel execution, request aggregation circuit 222 adds a new entry to identifiers 224. As another example, in response to receiving a memory request that includes a parallel execution group identifier that is not yet on the list, a new parallel execution group is formed including the execution unit that sent the parallel execution group identifier. As additional memory requests are received that include the parallel execution group identifier, corresponding execution units are added to the parallel execution group. Subsequently, flow 300 proceeds to block 312.

If the identifier corresponding to the memory request corresponds to the list, at block 306, the request aggregation circuit determines whether a corresponding memory request has already been sent, requesting the execution data. If the request for execution data has not yet been sent, at block 312, a single representative request for the execution data is sent. For example, in response to request aggregation circuit 222 determining that a request for execution data has not yet been sent, a single representative request is sent from request aggregation circuit 222 to memory 228. Subsequently, flow 300 proceeds to block 316.

If the request for execution data has already been sent, at block 310, the request aggregation circuit determines whether the execution data has been received from the memory. If the execution data has not yet been received, at block 316, the request aggregation circuit awaits the execution data from the memory. Subsequently, flow 300 proceeds to block 314.

If the execution data has already been received, at block 314, the request aggregation circuit determines whether all expected requests for the execution data have been received. For example, if request aggregation circuit 222 is expecting execution units 206-1 through 206-4 to each request the execution data, request aggregation circuit 222 determines whether requests for the execution data for each execution unit 206 has been received. If all expected requests for the execution data have not yet been received, at block 320, the request aggregation circuit determines whether a timeout duration has expired. If the timeout duration has not yet expired, the request aggregation circuit continues to wait until either all expected requests for the execution data are received or the timeout duration expires, whichever occurs first. Subsequently, flow 300 proceeds to block 318.

If all expected requests for the execution data are received or the timeout duration expires, at block 318, the execution data is returned to the requesting execution units. In various implementations, the execution data is returned via multicasting the execution data or via individual messages to each requesting execution unit. Accordingly, an example of combining parallel processing memory traffic is depicted.

FIG. 4 illustrates a pair of examples 400 and 405 that depict a specific way to utilize a request aggregation circuit 202 in accordance with some implementations. Example 400 illustrates execution units 206, request aggregation circuit 202, identifiers 204, and memory 208 of FIG. 2. Additionally, example 400 shows that execution unit 206-1 is performing a first portion 402-1 of a parallel execution, execution unit 206-3 is performing a second portion 402-2 of the parallel execution, and execution unit 206-4 is performing a third portion 402-3 of the parallel execution. Execution unit 206-2 is not performing the parallel execution. In the illustrated implementation, identifiers 204 are logical identifiers (e.g., logical workgroup masks) that are specific to the respective portions of the parallel execution. In some implementations, identifiers 204 are translated into physical identifiers as part of the parallel execution. Accordingly, a memory request from execution unit 206-1 is recognized as corresponding to first portion 402-1 based on a logical identifier.

Example 405 shows the parallel execution of example 400 at a later point in time where the portions 402 of the parallel execution have been removed from execution units 206 (e.g., via a context switch) and subsequently returned to execution units 206.

However, execution unit 206-1 is now performing the second portion 402-2 of the parallel execution, execution unit 206-2 is performing the first portion 402-1 of the parallel execution, and execution unit 206-4 is still performing the third portion 402-3 of the parallel execution. Accordingly, a memory request from execution unit 206-2 is recognized by system hardware (e.g., request aggregation circuit 202) as corresponding to first portion 402-1. In other words, because request aggregation circuit 202 identifies groups using logical identifiers in identifiers 204 as opposed to physical identifiers, the portions 402 of the parallel execution need not be returned to their original execution units after being removed. This allows the processing system to more flexibly assign processes to execution units 206, as compared to a system where identifiers 204 uses device identifiers corresponding to execution units 206.

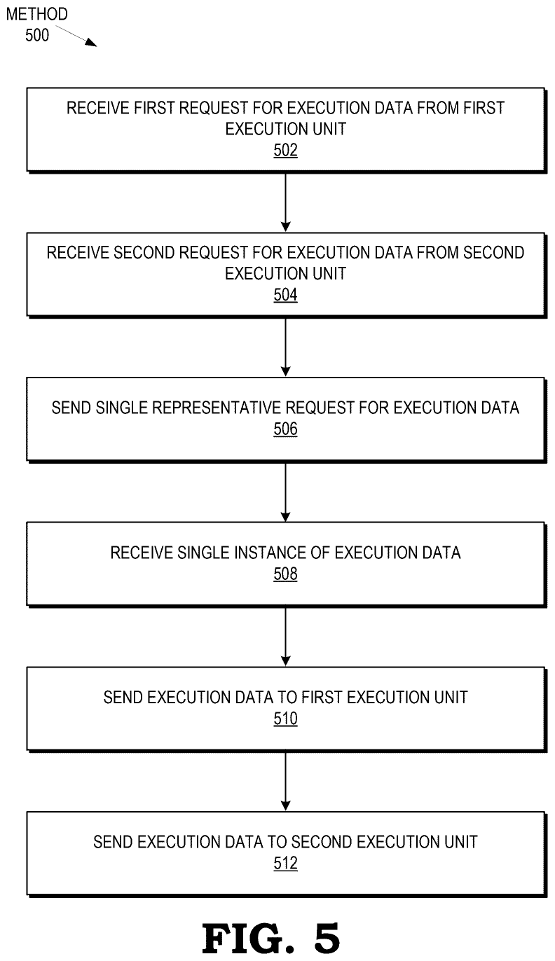

FIG. 5 is a flow diagram illustrating a method 500 of combining received memory requests and providing received data in accordance with some implementations. In some implementations, various portions are performed in another order. For example, in some implementations, blocks 510 and 512 are performed together as part of a multicast. As another example, in some implementations, blocks 506, 508, or both are performed before block 504. In some implementations, method 500 is initiated by one or more processors in response to one or more instructions stored by a computer readable storage medium.

At block 502, a first request for execution data is received from a first execution unit of a plurality of execution units performing respective portions of a parallel execution. For example, request aggregation circuit 202 of FIG. 2 receives a request for execution data from execution unit 206-2. At block 504, a second request for execution data is received from a second execution unit of the plurality of execution units. For example, request aggregation circuit 202 receives a request for execution data from execution unit 206-4.

At block 506, a single representative request for the execution data is sent on behalf of the plurality of execution units. For example, a representative request is sent to memory 208 on behalf of execution units 206-2 and 206-4. At block 508, a single instance of the execution data is received in response to the representative request. For example, a single instance of the execution data is received from memory 208.

At block 510, the execution data is sent to the first execution unit. At block 512, the execution data is sent to the second execution unit. For example, the execution data is multicast from request aggregation circuit 202. As another example, the execution data is separately sent to execution units 206-2 and 206-4. Accordingly, a method of combining received memory requests and providing received data is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations. “Circuitry” and “circuit” are used throughout this disclosure interchangeably.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

1. A system comprising:
a processor comprising a plurality of execution units configured to perform respective portions of a parallel execution, wherein the execution units are each configured to request respective execution data via a respective memory request; and
a request aggregation circuit configured to combine received memory requests from the execution units, by:
identifying, based on one or more parallel execution group identifiers included in the memory requests, a plurality of memory requests from different respective requesting ones of the plurality of execution units as corresponding to the same execution data;
sending a single representative memory request for the execution data;
receiving a single instance of the execution data; and
providing the respective execution data to each of the requesting ones of the plurality of execution units.

2. The system of claim 1, wherein identifying the plurality of memory requests comprises comparing parallel execution group identifiers of the memory requests to a stored set of parallel execution group identifiers maintained by the request aggregation circuit.

3. The system of claim 2, wherein the stored set of parallel execution group identifiers comprises a plurality of logical identifiers that correspond to respective portions of the parallel execution.

4. The system of claim 1, wherein the memory request is a load multicast instruction.

5. The system of claim 1, wherein identifying the plurality of memory requests comprises detecting, in a memory request, an indication that the memory request is part of a parallel execution group and dynamically adding a corresponding execution unit to the parallel execution group.

6. The system of claim 1, further comprising:
a second request aggregation circuit configured to combine received memory requests from a second plurality of execution units, wherein the request aggregation circuit and the second request aggregation circuit are hierarchically arranged.

7. The system of claim 6, further comprising:
a third request aggregation circuit configured to combine received memory requests from the request aggregation circuit and from the second request aggregation circuit and to generate a further aggregated memory request to a memory external to the processor.

8. The system of claim 7, wherein the third request aggregation circuit is separate from the processor.

9. The system of claim 1, wherein the plurality of execution units are shader engines, compute units, single instruction multiple data (SIMD) units, or any combination thereof.

10. A method comprising:
receiving a first request for execution data from a first execution unit of a plurality of execution units performing respective portions of a parallel execution;
receiving a second request for the execution data from a second execution unit of the plurality of execution units;
identifying, based on one or more parallel execution group identifiers included in the first and second requests, the identifiers corresponding to the same execution data;
sending, to a memory, a single representative request for the execution data on behalf of the first execution unit and the second execution unit;
receiving a single instance of the execution data in response to the representative request; and
multicasting the execution data to the first execution unit and the second execution unit.

11. The method of claim 10, wherein the second request for the execution data is received subsequent to sending the representative request for the execution data.

12. (canceled)

13. The method of claim 10, wherein identifying comprises comparing the parallel execution group identifiers of the first request and the second request to a stored set of parallel execution group of identifiers corresponding to portions of the parallel execution, wherein sending the representative request is performed in response to determining that the first request corresponds to a respective parallel execution group identifier of the stored set.

14. The method of claim 13, further comprising:
subsequent to multicasting the execution data, receiving a third request for second execution data from a third execution unit of the plurality of execution units, wherein the third execution unit is different from the first execution unit; and
identifying the third execution unit as running a portion of the parallel execution previously run by the first execution unit based on the third request including a parallel execution group identifier corresponding to the same parallel execution group identifier of the first request, wherein the parallel execution group identifier is a logical identifier.

15. A shader processing unit comprising:
a memory configured to store execution data;
a plurality of shader engines configured to perform respective portions of a parallel execution, wherein the shader engines are each configured to request respective execution data via a respective memory request; and
a request aggregation circuit configured to combine received memory requests from the shader engines, by:
identifying, based on one or more parallel execution group identifiers included in the memory requests, a plurality of memory requests from different respective requesting ones of the plurality of shader engines as corresponding to same execution data;
sending a single representative request to the memory for the same execution data;
receiving a single instance of the same execution data from the memory; and
providing a separate instance of the same execution data to each of the requesting ones of the plurality of shader engines.

16. (canceled)

17. The shader processing unit of claim 15, wherein the request aggregation circuit is configured to wait until all requesting shader engines corresponding to the one or more parallel execution group identifiers request the same execution data or until a timeout duration expires before providing the separate instances of the same execution data to the shader engines corresponding to the identified memory requests.

18. The shader processing unit of claim 17, wherein the request aggregation circuit is configured to identify shader engines corresponding to the one or more parallel execution group identifiers that do not request the same execution data before the timeout duration expires.

19. The shader processing unit of claim 18, wherein the request aggregation circuit is configured to refrain from waiting the timeout duration in response to receiving a request for the same execution data from a shader engine identified as failing to request previous same execution data prior to expiration of a previous timeout duration.

20. The shader processing unit of claim 18, wherein the request aggregation circuit is configured to refrain from waiting the timeout duration in response to determining that each shader engine corresponding to the one or more parallel execution group of identifiers that has failed to request the same execution data previously failed to request previous same execution data prior to expiration of a previous timeout duration.

21. The system of claim 3, wherein the logical identifiers are translated into physical identifiers associated with the execution units during execution of the parallel execution.

22. The system of claim 1, wherein the request aggregation circuit is further configured to wait to provide the execution data to the requesting execution until all expected memory requests of the parallel execution group have been received or until expiration of a timeout duration.
